(19) United States
(12) Patent Application Publication
(10) Pub. No.: US 2016/0001608 A1
(43) Pub. Date: Jan. 7, 2016

(54) SIDEWALL DECORATION ON RIM GUARD

(71) Applicant: Bridgestone Americas Tire Operations, LLC, Nashville, TN (US)

(72) Inventors: David G. Abdallah, JR., Nolensville, TN (US); Natalie V. Weingart, Canton, OH (US); Paula R. Lundgren, Akron, OH (US); Keith A. Dumigan, Akron, OH (US)

(21) Appl. No.: 14/749,113

(22) Filed: Jun. 24, 2015

Related U.S. Application Data
(60) Provisional application No. 62/020,632, filed on Jul. 3, 2014.

(51) Int. Cl. B60C 13/02; B60C 5/00; B60C 13/00

(52) U.S. Cl. CPC B60C 13/02; B60C 13/001; B60C 5/00

(57) ABSTRACT

Various embodiments of a tire having a rim guard are disclosed. The rim guard may be configured to have reduced deflection and/or strain relative to the remainder of the tire's sidewall. As a result, decorative decals applied to the rim guard may be less likely to crack, disbond, or otherwise become damaged or deformed, leading to loss of function and/or detachment of the decal from the tire.

### CROSS-REFERENCE TO RELATED APPLICATIONS

This application claims priority from U.S. Provisional Patent Application No. 62/020,632, filed on Jul. 3, 2014, which is incorporated by reference herein in its entirety.

### BACKGROUND

Many vehicle tires, including pneumatic vehicle tires, undergo significant deflection in at least a portion of the tire's sidewall during operation. That is, the portion of the tire's sidewall near the tire's footprint may be deflected relative to the portion of the tire's sidewall away from the tire's footprint. Often, the tire's sidewall near the tire's footprint supports much of the load of the vehicle on that specific tire, which may result in the sidewall bulging, flexing, bending, or the like.

Often, manufacturers may wish to add decorations to a tire's sidewall. Such decorations may include lettering, numbering, designs, logos, appliqué, or other indicia. Decorations may be added at the time of manufacturing the tire, for example by curing a decal onto the tire during curing of the tire itself. Alternatively, decorations may be added post-manufacture, for example by adhering a decal to a cured tire. However, the tire's sidewall often flexes so much during operation on a vehicle that decals crack, disbond, or otherwise become damaged or deformed, leading to loss of function and/or detachment of the decal from the tire.

Additionally, many vehicle tires are equipped with a rim guard. The rim guard may be a positive geometry element extending from a radially inner portion of the tire's sidewall, near a bead region. The rim guard may include an increased gauge relative to the rest of the tire's sidewall. The rim guard may be configured to at least partially prevent damage to a vehicle wheel flange and/or disruption of the tire-flange interface that may result in pressure loss. Such damage to the vehicle wheel flange and/or disruption of the tire-flange interface may result from contact of the wheel with an object during operation, including for example a curb. Due to at least one of its position near the radially inner portion of the tire's sidewall and its increased gauge, the rim guard may not experience the flexion, bending, deformation, and the like experienced by the remainder of the tire's sidewall.

What is needed is a tire having a rim guard configured for accepting decorations such as decals.

### SUMMARY

In one embodiment, a tire is provided, the tire comprising: a sidewall having a radially inner portion; a rim guard oriented in the radially inner portion, wherein the rim guard includes a radially outer edge and a radially inner edge; and a decorative decal oriented on at least one of the radially outer edge and the radially inner edge.

In another embodiment, a tire is provided, the tire comprising: a sidewall having a radially inner portion; a rim guard oriented in the radially inner portion, wherein the rim guard includes a radially outer edge, a radially inner edge, and an axially outer edge; and a decorative decal oriented on at least one of the radially outer edge, the radially inner edge, and the axially outer edge.

In one embodiment, a tire and wheel assembly is provided, the tire and wheel assembly comprising: a tire comprising: a sidewall having a radially inner portion; a rim guard oriented in the radially inner portion, wherein the rim guard includes a radially outer edge and a radially inner edge; and a decorative decal oriented on at least one of the radially outer edge and the radially inner edge; and a wheel having a radially outer flange portion; wherein the rim guard is oriented between about 25 mm and about 30 mm from the radially outer flange portion.

### BRIEF DESCRIPTION OF THE DRAWINGS

The accompanying figures, which are incorporated in and constitute a part of the specification, illustrate various example configurations, and are used merely to illustrate various example embodiments. In the figures, like elements bear like reference numerals.

FIG. 1 illustrates a partial sectional view of an example tire and wheel assembly having a rim guard.

FIG. 2 illustrates a partial sectional view of an example tire and wheel assembly having a rim guard.

FIG. 3 illustrates a side elevational view of an example tire having a rim guard.

FIG. 4 illustrates a side elevational view of an example tire having a rim guard.

FIG. 5 illustrates a side elevational view of an example tire having a rim guard.

FIG. 6 illustrates a partial sectional view of an example tire and wheel assembly having a rim guard.

FIG. 7 illustrates a partial sectional view of an example tire and wheel assembly having a rim guard.

FIG. 8 illustrates a partial sectional view of an example tire and wheel assembly having a rim guard

FIG. 9 illustrates a partial sectional view of an example tire and wheel assembly having a rim guard.

### DETAILED DESCRIPTION

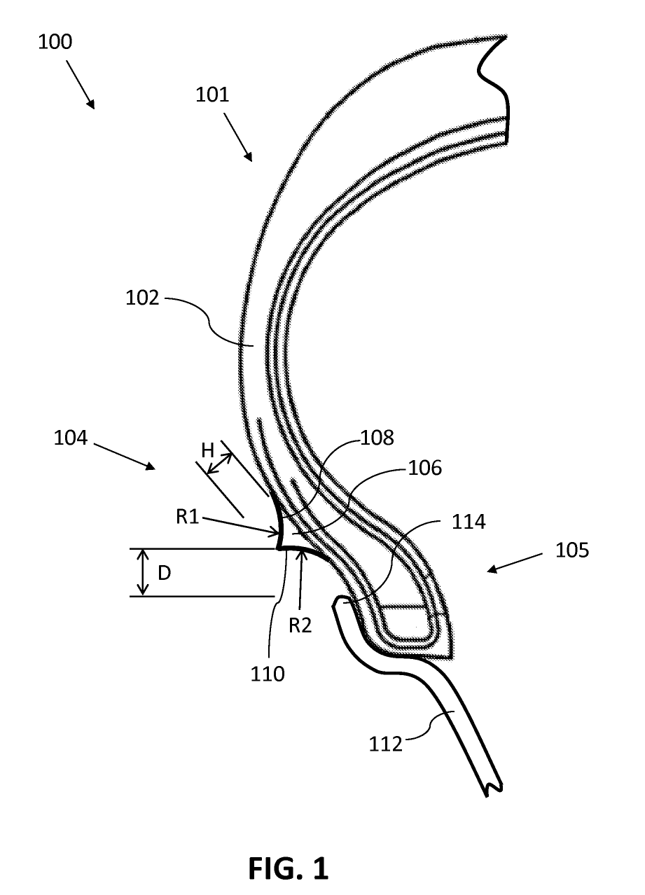

FIG. 1 illustrates a partial section view of a tire and wheel assembly 100 including a tire 101, and a wheel 112. Tire 101 may include a sidewall 102. Sidewall 102 may include a radially inner portion 104. Tire 101 may include a bead region 105. Sidewall 102 may include a rim guard 106 oriented in the radially inner portion 104. Rim guard 106 may include a radially outer edge 108 and a radially inner edge 110. Wheel 112 may include a radially outer flange portion 114.

Tire and wheel assembly 100 may be configured for use on any of a variety of vehicles, including self-propelled vehicles, towed trailers or wagons, irrigation systems, and the like.

Tire 101 may be a pneumatic tire or a non-pneumatic tire. Tire 101 may be any of a variety of tire types, including for example, a passenger tire, a light truck tire, a truck and bus radial tire, an agricultural tire, an irrigation tire, an off-the-road tire, an ATV tire, a radial ply tire, a bias ply tire, and the like.

Sidewall 102 may be similar to a conventional sidewall found in a tire. Sidewall 102 may include a radially inner portion 104. Radial inner portion 104 may extend between the remainder of sidewall 102, and the bead region 105. Radial inner portion 104 may contact bead region 105. Radial inner portion 104 may be oriented radially outwardly of radially outer flange portion 114 (when tire 101 is mounted on wheel 112) and the remainder of sidewall 102.

Rim guard 106 may include a substantially triangular cross-section. Rim guard 106 may include a substantially trapezoidal cross-section. Rim guard 106 may include any of a variety of cross-sections, including any regular or irregular shape. Rim guard 106 may be a positive element, extending substantially axially from radial inner portion 104.

Rim guard 106 may include a curved radially outer edge 108. Radially outer edge 108 may include a concave edge. Radially outer edge 108 may include a convex edge.

Radially outer edge 108 may include a substantially flat edge. Radially outer edge 108 may include a flat edge. Radially outer edge 108 may include a substantially flat edge, having a cross-section that is substantially straight from sidewall 102 to the apex of rim guard 106.

Radially outer edge 108 may include a radius R1. Radius R1 may be between about 10 mm and about 400 mm. Radius R1 may be between about 15 mm and about 300 mm. Radius R1 may be between about 20 mm and about 200 mm. Radius R1 may be between about 20 mm and about 150 mm. Radius R1 may be between about 20 mm and about 100 mm. Radius R1 may be between about 30 mm and about 90 mm. Radius R1 may be between about 40 mm and about 80 mm. Radius R1 may be about 40 mm. Radius R1 may be about 80 mm. Radius R1 may be any value within the ranges recited herein, for example 18 mm, 42 mm, 210 mm, and the like. Radius R1 may include a range having any of the upper and lower limits recited herein. Radius R1 may include any subrange within any range recited herein.

Rim guard 106 may include a curved radially inner edge 110. Radially inner edge 110 may include a concave edge. Radially inner edge 110 may include a convex edge. Radially inner edge 110 may include a substantially flat edge. Radially inner edge 110 may include a radius R2. Radius R2 may be between about 5 mm and about 40 mm. Radius R2 may be between about 10 mm and about 35 mm. Radius R2 may be between about 12 mm and about 30 mm. Radius R2 may be about 15 mm. Radius R2 may be any value within the ranges recited herein. Radius R2 may include a range having any of the upper and lower limits recited herein.

Rim guard 106 may have a height H, generally measuring the distance from sidewall 102 to its axially outer terminal point. Height H may include any of a variety of heights commonly used with rim guards. Height H may be between about 1 mm and about 10 mm. Height H may be between about 2 mm and about 8 mm. Height H may be between about 3 mm and about 6 mm. Height H may be about 3 mm. Height H may be about 4 mm. Height H may be about 6 mm. Height H may be any value within the ranges recited herein. Height H may include a range having any of the upper and lower limits recited herein.

Rim guard 106 may be oriented a distance D from radially outer flange portion 114 (when tire 101 is mounted on wheel 112). Distance D may measure a distance from radially outer flange portion 114 to the axially outer terminal point of rim guard 106. Distance D may include any of a variety of distances commonly used with rim guards. Distance D may be between about 15 mm and about 40 mm. Distance D may be between about 20 mm and about 36 mm. Distance D may be between about 25 mm and about 30 mm. Distance D may be about 28.5 mm. Distance D may be about 29.5 mm. Distance D may be any value within the ranges recited herein. Distance D may include a range having any of the upper and lower limits recited herein.

Rim guard 106 may include a decoration. Rim guard 106 may include any of a variety of decorations, including for example lettering, numbering, designs, logos, appliqué, indicia, or the like. Rim guard 106 may include decorations added at the time of manufacturing the tire, for example by curing a decal onto the tire during curing of the tire itself. Rim guard 106 may include decorations added post-manufacture, for example by adhering a decal to a cured tire.

Rim guard 106 may include decorations in any of a variety of portions of rim guard 106, including for example at least one of radially outer edge 108 and radially inner edge 110. Rim guard 106 may include decorations on or near the axially outer terminal point of rim guard 106. Rim guard 106 may include decorations on both radially outer edge 108 and radially inner edge 110. Rim guard 106 may extend completely around the circumference of radially inner portion 104. Rim guard 106 may extend partially around the circumference of radially inner portion 104. Rim guard 106 may include decorations about at least a portion of the circumference of radially inner portion 104.

Rim guard 106 may include an increased gauge as compared to the remainder of sidewall 102. As a result, rim guard 106 may experience less deflection during operation than the remainder of sidewall 102. As a result, rim guard 106 may experience less strain during operation than the remainder of sidewall 102.

Rim guard 106 may be located in radially inner portion 104. As a result, rim guard 106 may experience less deflection during operation than the remainder of sidewall 102. As a result, rim guard 106 may experience less strain during operation than the remainder of sidewall 102.

As a result of rim guard 106's decreased deflection and/or strain as compared to the remainder of sidewall 102, decorative decals applied to rim guard 106 may be less likely to crack, disbond, or otherwise become damaged or deformed, leading to loss of function and/or detachment of the decal from the tire.

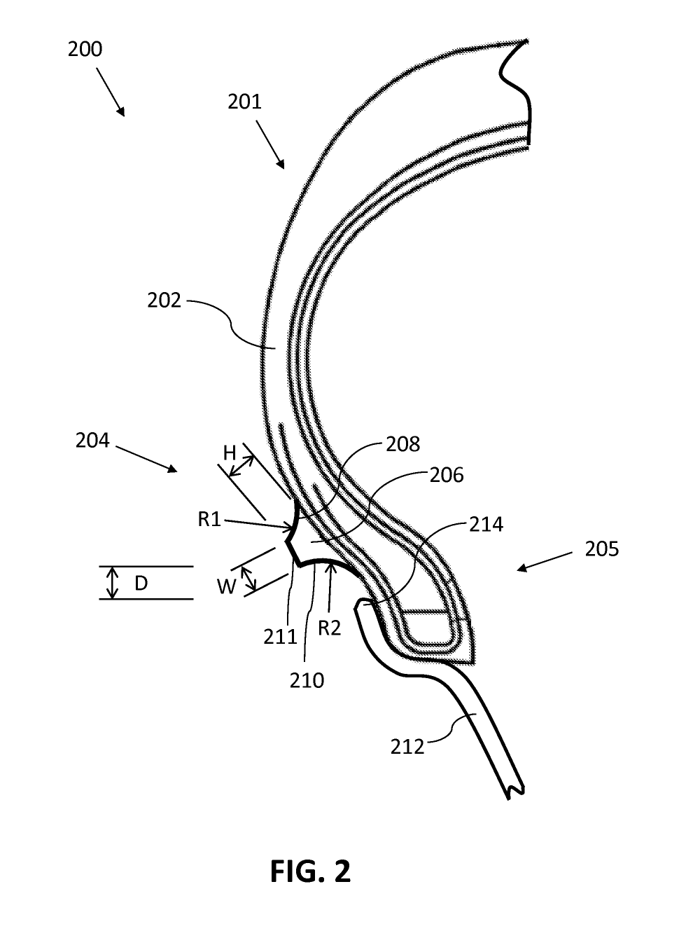

FIG. 2 illustrates a partial section view of a tire and wheel assembly 200 including tire 201, and wheel 212. Tire 201 may include sidewall 202. Sidewall 202 may include radially inner portion 204. Tire 201 may include bead region 205. Sidewall 202 may include a rim guard 206 oriented in the radially inner portion 204. Rim guard 206 may include a radially outer edge 208 and a radially inner edge 210. Rim guard 206 may include an axially outer edge 211. Wheel 212 may include radially outer flange portion 214.

Rim guard 206 may include a curved radially outer edge 208. Radially outer edge 208 may include a concave edge. Radially outer edge 208 may include a convex edge.

Radially outer edge 208 may include a substantially flat edge. Radially outer edge 208 may include a flat edge. Radially outer edge 208 may include a substantially flat edge, having a cross-section that is substantially straight from sidewall 202 to the apex of rim guard 206.

Radially outer edge 208 may include a radius R1. Radius R1 may be between about 10 mm and about 400 mm. Radius R1 may be between about 15 mm and about 300 mm. Radius R1 may be between about 20 mm and about 200 mm. Radius R1 may be between about 20 mm and about 150 mm. Radius R1 may be between about 20 mm and about 100 mm. Radius R1 may be between about 30 mm and about 90 mm. Radius R1 may be between about 40 mm and about 80 mm. Radius R1 may be about 40 mm. Radius R1 may be about 80 mm. Radius R1 may be any value within the ranges recited herein, for example 18 mm, 42 mm, 210 mm, and the like. Radius R1 may include a range having any of the upper and lower limits recited herein. Radius R1 may include any subrange within any range recited herein.

Rim guard 206 may include a curved radially inner edge 210. Radially inner edge 210 may include a concave edge. Radially inner edge 210 may include a convex edge. Radially inner edge 210 may include a substantially flat edge. Radially inner edge 210 may include a radius R2. Radius R2 may be between about 5 mm and about 40 mm. Radius R2 may be between about 10 mm and about 35 mm. Radius R2 may be between about 12 mm and about 30 mm. Radius R2 may be about 15 mm. Radius R2 may be any value within the ranges recited herein. Radius R2 may include a range having any of the upper and lower limits recited herein.

Rim guard 206 may include axially outer edge 211. Axially outer edge 211 may include a flat edge. Axially outer edge 211 may include a substantially flat edge having a cross-section that is substantially planar. Axially outer edge 211 may include a curved edge. Axially outer edge 211 may include a concave edge. Axially outer edge 211 may include a convex edge. Axially outer edge may include a width W. Width W may be between about 1 mm and about 6 mm. Width W may be between about 2 mm and about 4 mm. Width W may be between about 3 mm. Width W may be any value within the ranges recited herein. Width W may include a range having any of the upper and lower limits recited herein.

Rim guard 206 may have a height H, generally measuring the distance from sidewall 102 to its axially outer terminal point. Height H may include any of a variety of heights commonly used with rim guards. Height H may be between about 1 mm and about 10 mm. Height H may be between about 2 mm and about 8 mm. Height H may be between about 3 mm and about 6 mm. Height H may be about 3 mm. Height H may be about 4 mm. Height H may be about 6 mm. Height H may be any value within the ranges recited herein. Height H may include a range having any of the upper and lower limits recited herein.

Rim guard 206 may be oriented a distance D from radially outer flange portion 214 (when tire 201 is mounted on wheel 212). Distance D may measure a distance from radially outer flange portion 214 to the radially inner point of axially outer edge 211 of rim guard 206. Distance D may include any of a variety of distances commonly used with rim guards. Distance D may be between about 15 mm and about 40 mm. Distance D may be between about 20 mm and about 36 mm. Distance D may be between about 25 mm and about 30 mm. Distance D may be about 28.5 mm. Distance D may be about 29.5 mm. Distance D may be any value within the ranges recited herein. Distance D may include a range having any of the upper and lower limits recited herein.

Rim guard 206 may include a decoration. Rim guard 206 may include any of a variety of decorations, including for example lettering, numbering, designs, logos, appliqué, indicia, or the like. Rim guard 206 may include decorations added at the time of manufacturing the tire, for example by curing a decal onto the tire during curing of the tire itself. Rim guard 206 may include decorations added post-manufacture, for example by adhering a decal to a cured tire.

Rim guard 206 may include decorations in any of a variety of portions of rim guard 206, including for example at least one of radially outer edge 208, radially inner edge 210, and axially outer edge 211. Rim guard 206 may include decorations on each of radially outer edge 208, radially inner edge 210, and axially outer edge 211. Rim guard 206 may extend completely around the circumference of radially inner portion 204. Rim guard 206 may extend partially around the circumference of radially inner portion 204. Rim guard 206 may include decorations about at least a portion of the circumference of radially inner portion 204.

Rim guard 206 may include an increased gauge as compared to the remainder of sidewall 202. As a result, rim guard 206 may experience less deflection during operation than the remainder of sidewall 202. As a result, rim guard 206 may experience less strain during operation than the remainder of sidewall 202.

Rim guard 206 may be located in radially inner portion 204. As a result, rim guard 206 may experience less deflection during operation than the remainder of sidewall 202. As a result, rim guard 206 may experience less strain during operation than the remainder of sidewall 202.

As a result of rim guard 206's decreased deflection and/or strain as compared to the remainder of sidewall 202, decorative decals applied to rim guard 206 may be less likely to crack, disbond, or otherwise become damaged or deformed, leading to loss of function and/or detachment of the decal from the tire.

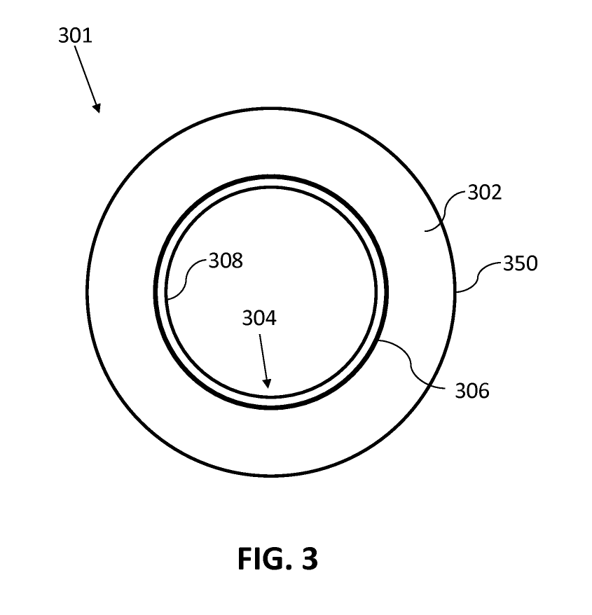

FIG. 3 illustrates a side elevational view of a tire 301 having a rim guard 306. Tire 301 may include a sidewall 302. Sidewall 302 may include a radially inner portion 304. Tire 301 may include a bead region 305. Tire 301 may include a running surface 350.

Rim guard 306 may extend circumferentially about the entirety of radially inner portion 304. Rim guard 306 may include decorations applied about the entire circumference of rim guard 306. Rim guard 306 may include decorations applied about a portion of the circumference of rim guard 306.

Rim guard 306 may extend partially about the circumference of radially inner portion 304. Rim guard 306 may include decorations applied about a portion of the circumference of rim guard 306.

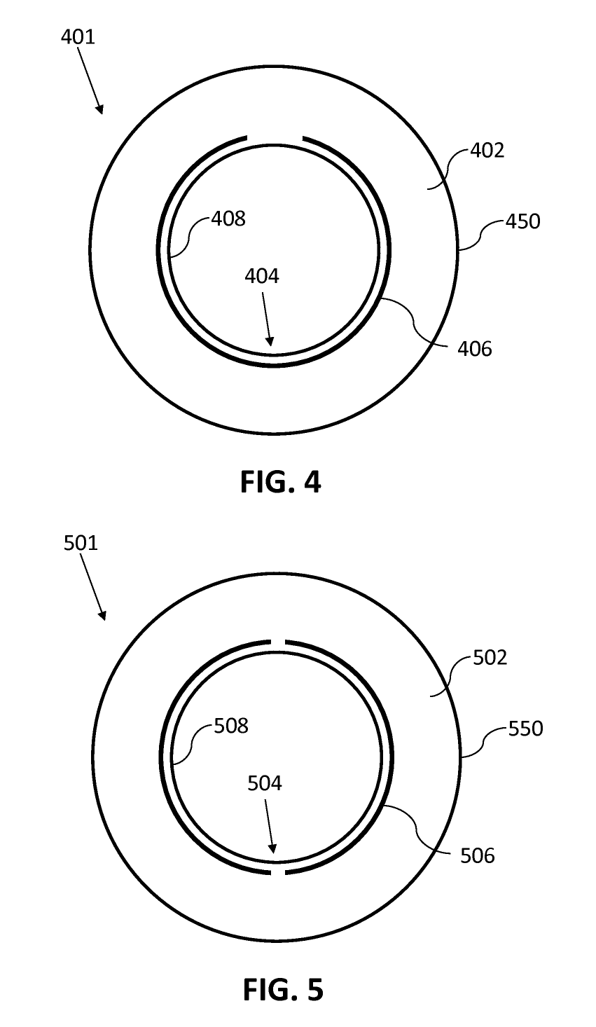

FIG. 4 illustrates a side elevational view of a tire 401 having a rim guard 406. Tire 401 may include a sidewall 402. Sidewall 402 may include a radially inner portion 404. Tire 401 may include a bead region 405. Tire 401 may include a running surface 450.

Rim guard 406 may extend partially about the circumference of radially inner portion 404. Rim guard 406 may include decorations applied about a portion of the circumference of rim guard 406.

FIG. 5 illustrates a side elevational view of a tire 501 having a rim guard 506. Tire 501 may include a sidewall 502. Sidewall 502 may include a radially inner portion 504. Tire 501 may include a bead region 505. Tire 501 may include a running surface 550.

Rim guard 506 may extend partially about the circumference of radially inner portion 504. Rim guard 506 may include decorations applied about a portion of the circumference of rim guard 506.

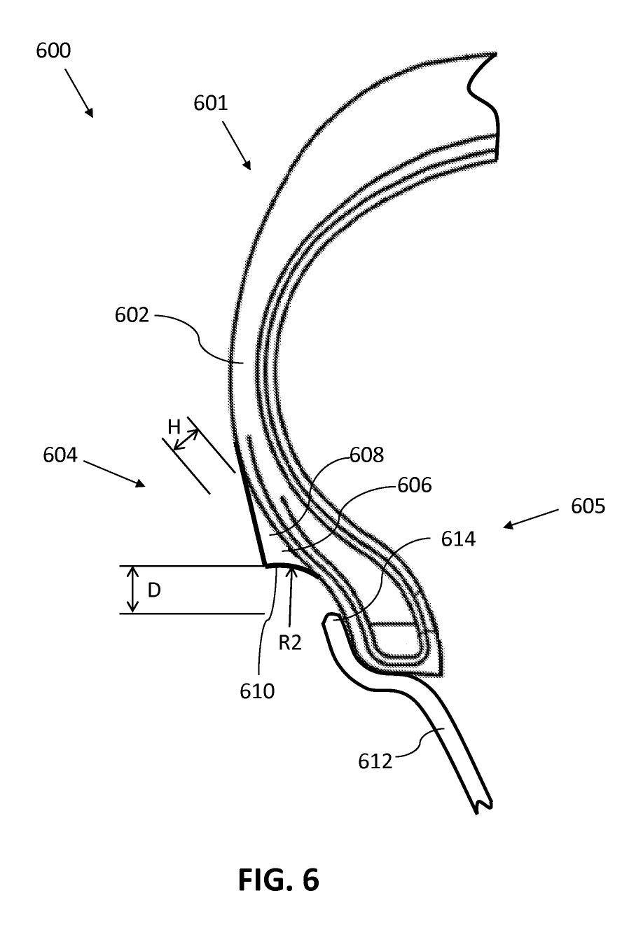

FIG. 6 illustrates a partial section view of a tire and wheel assembly 600 including a tire 601, and a wheel 612. Tire 601 may include a sidewall 602. Sidewall 602 may include a radially inner portion 604. Tire 601 may include a bead region 605. Sidewall 602 may include a rim guard 606 oriented in the radially inner portion 604. Rim guard 606 may include a radially outer edge 608 and a radially inner edge 610. Wheel 612 may include a radially outer flange portion 614.

Rim guard 606 may include a radially outer edge 608 having a flat, or planar, edge. Radially outer edge 608 may include a substantially flat, or planar, edge. Radially outer edge 608 may include a substantially flat edge, having a cross-section that is substantially planar.

Rim guard 606 may include a curved radially inner edge 610. Radially inner edge 610 may include a concave edge. Radially inner edge 610 may include a convex edge. Radially inner edge 610 may include a radius R2. Radius R2 may be any value within the ranges recited herein. Radius R2 may include a range having any of the upper and lower limits recited herein.

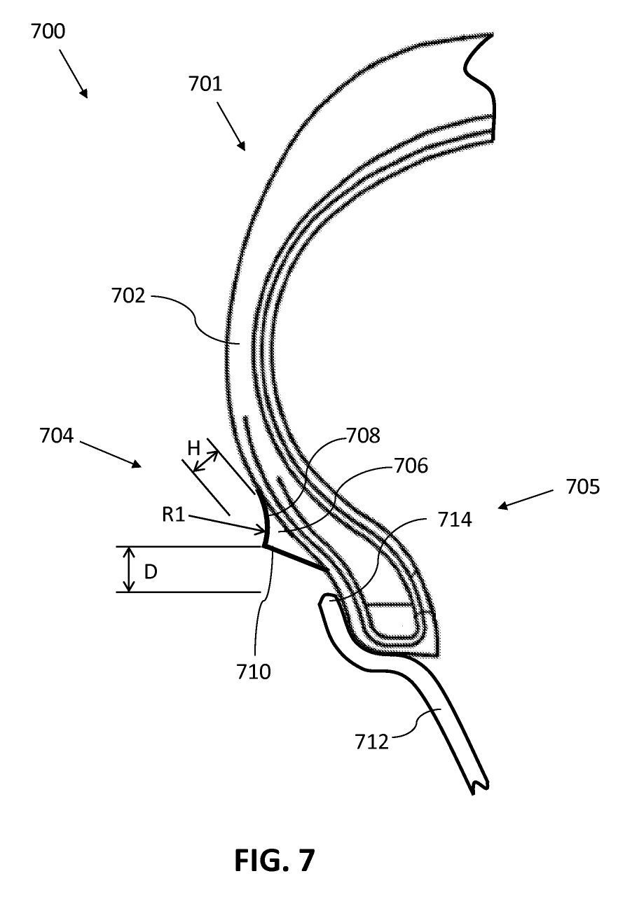

FIG. 7 illustrates a partial section view of a tire and wheel assembly 700 including a tire 701, and a wheel 712. Tire 701 may include a sidewall 702. Sidewall 702 may include a radially inner portion 704. Tire 701 may include a bead region 705. Sidewall 702 may include a rim guard 706 oriented in the radially inner portion 704. Rim guard 706 may include a radially outer edge 708 and a radially inner edge 710. Wheel 712 may include a radially outer flange portion 714.

Rim guard 706 may include a curved radially outer edge 708. Radially outer edge 708 may include a concave edge. Radially outer edge 708 may include a convex edge. Radially outer edge 708 may include a radius R1. Radius R1 may include a range having any of the upper and lower limits recited herein. Radius R1 may include any subrange within any range recited herein.

Rim guard 706 may include a radially inner edge 710 having a flat edge. Radially inner edge 710 may include a substantially flat edge. Radially inner edge 710 may include a flat edge. Radially inner edge 710 may include a substantially flat edge, having a cross-section that is substantially planar.

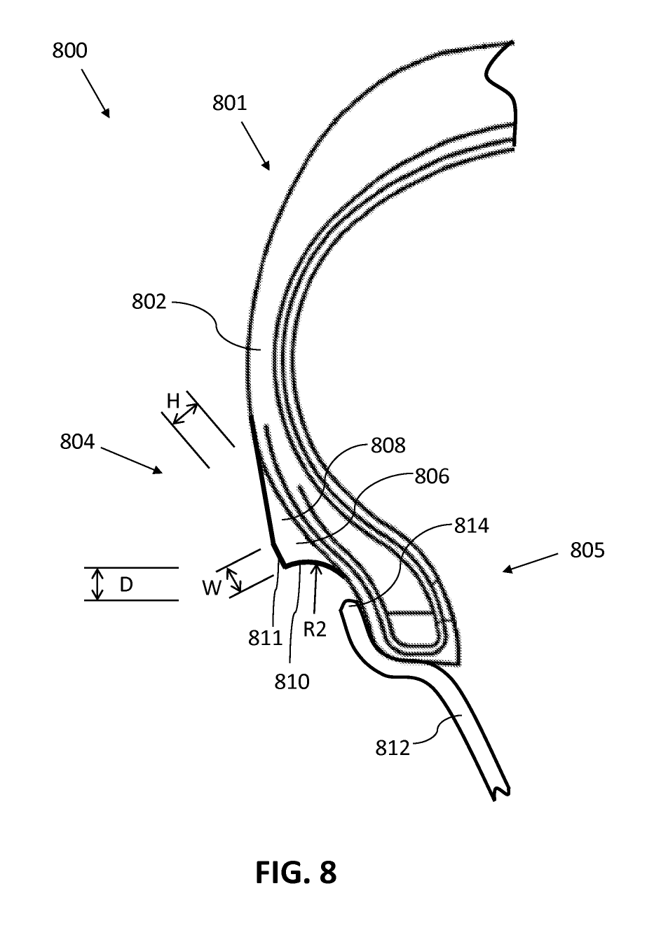

FIG. 8 illustrates a partial section view of a tire and wheel assembly 800 including tire 801, and wheel 812. Tire 801 may include sidewall 802. Sidewall 802 may include radially inner portion 804. Tire 801 may include bead region 805. Sidewall 802 may include a rim guard 806 oriented in the radially inner portion 804. Rim guard 806 may include a radially outer edge 808 and a radially inner edge 810. Rim guard 806 may include an axially outer edge 811. Wheel 812 may include radially outer flange portion 814.

Rim guard 806 may include a radially outer edge 808 having a flat edge. Radially outer edge 808 may include a substantially flat edge. Radially outer edge 808 may include a flat edge. Radially outer edge 808 may include a substantially flat edge, having a cross-section that is substantially planar.

Rim guard 806 may include a curved radially inner edge 810. Radially inner edge 810 may include a concave edge. Radially inner edge 810 may include a convex edge. Radially inner edge 810 may include a radius R2. Radius R2 may be any value within the ranges recited herein. Radius R2 may include a range having any of the upper and lower limits recited herein.

Rim guard 806 may include axially outer edge 811. Axially outer edge 811 may include a flat edge. Axially outer edge 811 may include a substantially flat edge. Width W may be any value within the ranges recited herein. Width W may include a range having any of the upper and lower limits recited herein.

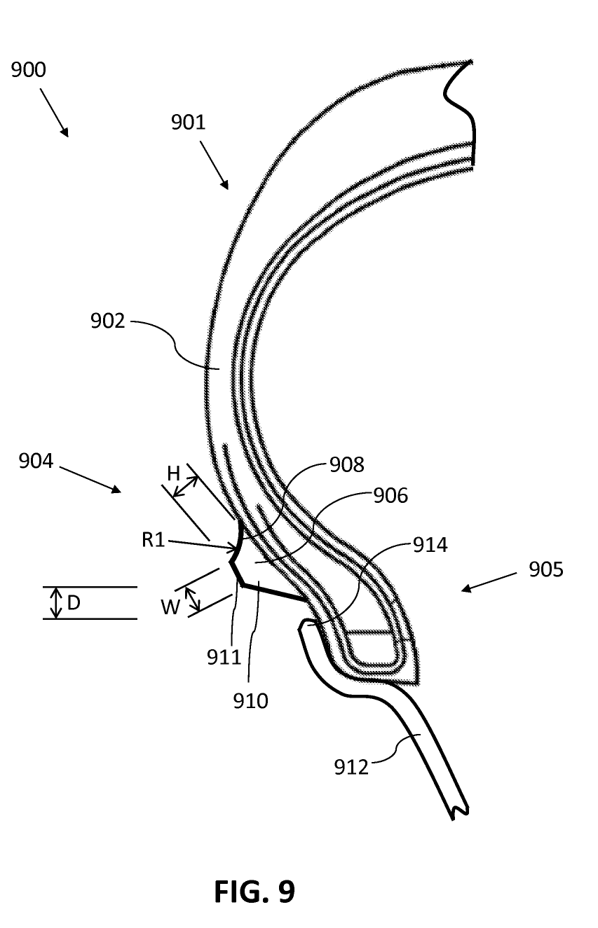

FIG. 9 illustrates a partial section view of a tire and wheel assembly 900 including tire 901, and wheel 912. Tire 901 may include sidewall 902. Sidewall 902 may include radially inner portion 904. Tire 901 may include bead region 905. Sidewall 902 may include a rim guard 906 oriented in the radially inner portion 904. Rim guard 906 may include a radially outer edge 908 and a radially inner edge 910. Rim guard 906 may include an axially outer edge 911. Wheel 912 may include radially outer flange portion 914.

Rim guard 906 may include a curved radially outer edge 908. Radially outer edge 908 may include a concave edge. Radially outer edge 908 may include a convex edge. Radially outer edge 908 may include a radius R1. Radius R1 may include a range having any of the upper and lower limits recited herein. Radius R1 may include any subrange within any range recited herein.

Rim guard 906 may include a radially inner edge 910 having a flat edge. Radially inner edge 910 may include a substantially flat edge. Radially inner edge 910 may include a flat edge. Radially inner edge 910 may include a substantially flat edge, having a cross-section that is substantially planar.

Rim guard 906 may include axially outer edge 911. Axially outer edge 911 may include a flat edge. Axially outer edge 911 may include a substantially flat edge. Width W may be any value within the ranges recited herein. Width W may include a range having any of the upper and lower limits recited herein.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. A tire, comprising:
a sidewall having a radially inner portion;
a rim guard oriented in the radially inner portion, wherein the rim guard includes a radially outer edge and a radially inner edge; and
a decorative decal oriented on at least one of the radially outer edge and the radially inner edge.

2. The tire of claim 1, wherein the decorative decal is added to the tire before the tire is cured.

3. The tire of claim 1, wherein the decorative decal is added to the tire after the tire is cured.

4. The tire of claim 1, wherein at least one of the rim guard and the decorative decal extends circumferentially about the entirety of the radially inner portion of the sidewall.

5. The tire of claim 1, wherein at least one of the rim guard and the decorative decal extends partially about the circumference of the radially inner portion of the sidewall.

6. The tire of claim 1, wherein at least one of the radially inner edge and the radially outer edge further comprises at least one of a flat edge, a concave edge, and a convex edge.

7. The tire of claim 1, wherein the radially outer edge comprises a substantially flat edge having a cross-section that is substantially planar.

8. A tire, comprising:
a sidewall having a radially inner portion;
a rim guard oriented in the radially inner portion, wherein the rim guard includes a radially outer edge, a radially inner edge, and an axially outer edge; and
a decorative decal oriented on at least one of the radially outer edge, the radially inner edge, and the axially outer edge.

9. The tire of claim 8, wherein the decorative decal is added to the tire before the tire is cured.

10. The tire of claim 8, wherein the decorative decal is added to the tire after the tire is cured.

11. The tire of claim 8, wherein at least one of the rim guard and the decorative decal extends circumferentially about the entirety of the radially inner portion of the sidewall.

12. The tire of claim 8, wherein at least one of the rim guard and the decorative decal extends partially about the circumference of the radially inner portion of the sidewall.

13. The tire of claim 8, wherein at least one of the radially inner edge, the radially outer edge, and the axially outer edge further comprises at least one of a flat edge, a concave edge, and a convex edge.

14. The tire of claim 8, wherein the radially outer edge comprises a substantially flat edge having a cross-section that is substantially planar.

15. A tire and wheel assembly, comprising:
a tire comprising:
a sidewall having a radially inner portion;
a rim guard oriented in the radially inner portion, wherein the rim guard includes a radially outer edge and a radially inner edge; and
a decorative decal oriented on at least one of the radially outer edge and the radially inner edge; and
a wheel having a radially outer flange portion;
wherein the rim guard is oriented between about 25 mm and about 30 mm from the radially outer flange portion.

16. The tire and wheel assembly of claim 15, wherein the decorative decal is added to the tire at least one of before the tire is cured and after the tire is cured.

17. The tire and wheel assembly of claim 15, wherein at least one of the rim guard and the decorative decal extends circumferentially about the entirety of the radially inner portion of the sidewall.

18. The tire and wheel assembly of claim 15, wherein at least one of the rim guard and the decorative decal extends partially about the circumference of the radially inner portion of the sidewall.

19. The tire and wheel assembly of claim 15, wherein at least one of the radially inner edge, the radially outer edge, and the axially outer edge of the tire further comprises at least one of a flat edge, a concave edge, and a convex edge.

20. The tire and wheel assembly of claim 15, wherein the radially outer edge of the tire comprises a substantially flat edge having a cross-section that is substantially planar.
